(19) United States
(12) Patent Application Publication
(10) Pub. No.: US 2025/0081259 A1
(43) Pub. Date: Mar. 6, 2025

(54) SYSTEMS AND METHODS FOR DEVICE AND/OR DEVICE TYPE IDENTIFICATION USING WIRELESS CHANNEL CHARACTERISTICS

(71) Applicant: PLUME DESIGN, INC., Palo Alto, CA (US)

(72) Inventors: Gašper ŠTUKELJ, Maribor (SL); Ha DO, Cumming, GA (US); Tingyi ZHU, Mountain View, CA (US); Richard CHANG, Los Altos Hills, CA (US); Sean LI, Campbell, CA (US); Charles KRING, Sunnyvale, CA (US); Miroslav SAMARDZIJA, Mountain View, CA (US); Kiran EDARA, Cupertino, CA (US)

(21) Appl. No.: 18/822,806

(22) Filed: Sep. 3, 2024

Related U.S. Application Data
(60) Provisional application No. 63/580,491, filed on Sep. 5, 2023.

(51) Int. Cl. H04W 76/11; H04W 84/12; H04W 88/08

(52) U.S. Cl. CPC H04W 76/11; H04W 84/12; H04W 88/08

(57) ABSTRACT

An access point of a wireless communication network may be configured to receive a solicited wireless communication from an electronic device in response to a request, the solicited wireless communication being transmitted by the electronic device over a channel of the wireless communication network. The access point may extract channel characteristics from the solicited wireless communication, the channel characteristics being timing-dependent effects on the channel associated with the solicited wireless communication. The access point may generate a device fingerprint based at least in part on the channel characteristics, the device fingerprint being specific to hardware of the electronic device. Using the device fingerprint, the access point or another device may determine an identification, indicative of at least one of an identity or a device type, of the electronic device based on a stored device profile representative of at least one authenticated electronic device.

### CROSS-REFERENCE TO RELATED APPLICATIONS

This application claims the benefit of U.S. Provisional Application No. 63/580,491, filed Sep. 5, 2023, which is incorporated by reference in its entirety.

### FIELD OF TECHNOLOGY

The present disclosure generally relates to computer-based systems configured for identifying devices and/or types of devices using characteristics of response signals in a wireless network communication.

### BACKGROUND OF TECHNOLOGY

Conventional wireless networks are deployed to users in a business, residence(s), public place or other location to provide network connectivity to various devices (e.g., mobile devices, tablets, televisions, Internet of Things (IoT) devices, laptops, media players, and the like). The users obtain network connectivity by authenticating a device with an access point of the network.

### SUMMARY OF DESCRIBED SUBJECT MATTER

In some aspects, the techniques described herein relate to a method including: receiving, by at least one processor associated with a wireless communication network, a solicited wireless communication from an electronic device in response to a request, the solicited wireless communication being transmitted by the electronic device over a channel of the wireless communication network to an access point; extracting, by the at least one processor, channel characteristics from the solicited wireless communication, the channel characteristics being timing-dependent effects on the channel associated with the solicited wireless communication; generating, by the at least one processor, a device fingerprint based at least in part on the channel characteristics, the device fingerprint being specific to hardware of the electronic device; and determining, by the at least one processor, an identification associated with the electronic device based at least in part on the device fingerprint matching a stored device profile representative of at least one pre-stored electronic device.

In some aspects, the techniques described herein relate to a method, wherein the at least one pre-stored electronic device includes a particular fingerprint of at least one previous electronic device that has been previously fingerprinted.

In some aspects, the techniques described herein relate to a method, wherein the identification is indicative of a particular device.

In some aspects, the techniques described herein relate to a method, wherein the identification is indicative of a particular type of device.

In some aspects, the techniques described herein relate to a method, wherein the particular type of device includes a particular device model.

In some aspects, the techniques described herein relate to a method, further including: communicating, by the at least one processor, the device fingerprint to a remote server, the remote server being configured to analyze the device fingerprint relative to the stored device profile; and receiving, by the at least one processor, an indication of the identification from the remote server in response to the device fingerprint.

In some aspects, the techniques described herein relate to a method, wherein the request includes an authentication challenge, and the response is derived from at least one pre-shared cryptographic secret.

In some aspects, the techniques described herein relate to a method, wherein the channel characteristics include at least one of: channel frequency response, or channel state information.

In some aspects, the techniques described herein relate to a method, wherein the access point includes a Wi-Fi access point.

In some aspects, the techniques described herein relate to a system including: at least one processor of a wireless network, wherein the at least one processor is configured to: receive a solicited wireless communication from an electronic device in response to a request, the solicited wireless communication being transmitted by the electronic device over a channel of the wireless communication network to an access point; extract channel characteristics from the solicited wireless communication, the channel characteristics being timing-dependent effects on the channel associated with the solicited wireless communication; generate a device fingerprint based at least in part on the channel characteristics, the device fingerprint being specific to hardware of the electronic device; and determine an identification associated with the electronic device based at least in part on the device fingerprint matching a stored device profile representative of at least one pre-stored electronic device.

In some aspects, the techniques described herein relate to a system, wherein the at least one pre-stored electronic device includes a particular fingerprint of at least one previous electronic device that has been previously fingerprinted.

In some aspects, the techniques described herein relate to a system, wherein the identification is indicative of a particular device.

In some aspects, the techniques described herein relate to a system, wherein the identification is indicative of a particular type of device.

In some aspects, the techniques described herein relate to a system, wherein the particular type of device includes a particular device model.

In some aspects, the techniques described herein relate to a system, further including: communicate the device fingerprint to a remote server, the remote server being configured to analyze the device fingerprint relative to the stored device profile; and receive an indication of the identification from the remote server in response to the device fingerprint.

In some aspects, the techniques described herein relate to a system, wherein the request includes an authentication challenge, and the response is derived from at least one pre-shared cryptographic secret.

In some aspects, the techniques described herein relate to a system, wherein the channel characteristics include at least one of: channel frequency response, or channel state information.

In some aspects, the techniques described herein relate to a system, wherein the access point includes a Wi-Fi access point.

In some aspects, the techniques described herein relate to a method including: receiving, by a Wi-Fi access point of a Wi-Fi network, a solicited wireless communication from an electronic device in response to a request, the solicited wireless communication being transmitted by the electronic device over a channel of the Wi-Fi network; extracting, by the Wi-Fi access point, channel characteristics from the solicited wireless communication, the channel characteristics being timing-dependent effects on the channel associated with the solicited wireless communication; generating, by the Wi-Fi access point, a device fingerprint based at least in part on the channel characteristics, the device fingerprint being specific to hardware of the electronic device; communicating, by the Wi-Fi access point, the device fingerprint to a remote server, the remote server being configured to analyze the device fingerprint relative to a stored device profile; receiving, by the Wi-Fi access point, an indication of identification from the remote server in response to the device fingerprint, the identification being indicative of at least one of a device identity or a device type; and determining, by the Wi-Fi access point, an authentication associated with the electronic device based at least in part on the indication of identification.

In some aspects, the techniques described herein relate to a method, wherein the channel characteristics include at least one of: channel frequency response, or channel state information.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 depicts a wireless networking system using an access point configured to employ channel characteristics of a wireless communication to identify an electronic device in accordance with one or more embodiments of the present disclosure.

FIG. 2 depicts an access point configured to employ channel characteristics of a wireless communication to identify an electronic device in accordance with one or more embodiments of the present disclosure.

FIG. 3 depicts a wireless networking system using an access point and an authentication server, the wireless networking system configured to employ channel characteristics of a wireless communication to identify an electronic device in accordance with one or more embodiments of the present disclosure.

FIG. 4 depicts an access point and authentication server to employ channel characteristics of a wireless communication to identify an electronic device in accordance with one or more embodiments of the present disclosure.

FIG. 5 depicts a block diagram of another computer-based system and platform for device authentication on a wireless network using channel characteristics of a wireless communication in accordance with one or more embodiments of the present disclosure.

FIG. 6 depicts illustrative schematics of an implementation of the cloud computing/architecture(s) in which embodiments of a system for device identification on a wireless network using channel characteristics of a wireless communication may be specifically configured to operate in accordance with some embodiments of the present disclosure.

FIG. 7 depicts illustrative schematics of another implementation of the cloud computing/architecture(s) in which embodiments of a system for device identification on a wireless network using channel characteristics of a wireless communication may be specifically configured to operate in accordance with some embodiments of the present disclosure.

### DETAILED DESCRIPTION

Various detailed embodiments of the present disclosure, taken in conjunction with the accompanying FIGS., are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

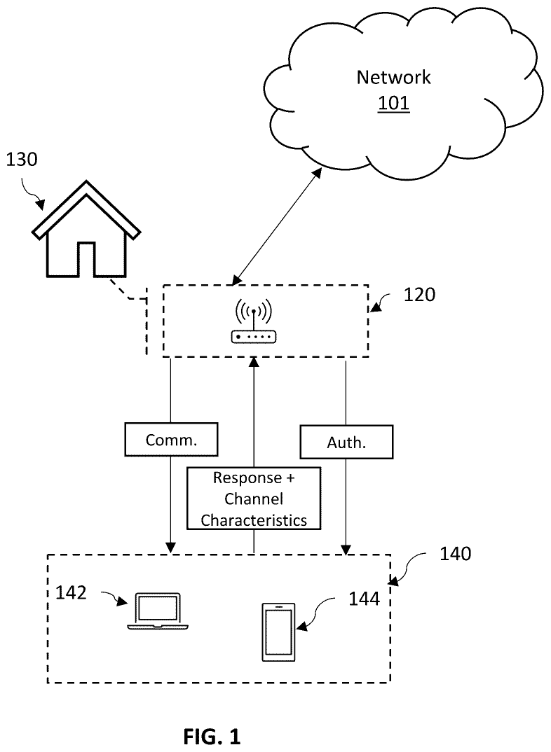

FIGS. 1 through 7 illustrate systems and methods of device identification on a wireless network using wireless channel characteristics associated with a communication by the device. The following embodiments provide technical solutions and technical improvements that overcome technical problems, drawbacks and/or deficiencies in the technical fields involving fraud and spoofing of devices to gain access to a wireless network, such as by spoofing device identifying data and/or stealing a password. As explained in more detail, below, technical solutions and technical improvements herein include aspects of improved device identification via the use of unique channel characteristics of wireless communications emitted by a device, which may lead to improved authentication, device typing, network optimization, analytics, network forensics, among other improvements to computer networking or any combination thereof. During normal operation of a wireless network (such as, e.g., a Wi-Fi network, Bluetooth connection, ZigBee network, Z-Wave network, Matter network, etc.) a client device may authenticate with an access point. Knowing that the client device will be performing a specific computation (related to the authentication), such as key derivation or other computation, the access point can reliably extract channel characteristics, such as a channel frequency response (CFR), channel state information (CSI), among others or any combination thereof, to extract a signature specific to the client device and/or device type of the client device by locating the computation in time. The extracted signature can then be compared to known signatures from a database to identify the client device.

In some embodiments, identification may include, e.g., (a) establishing identity relation, or establishing unknown class membership (e.g., device x and device y are the same device, or device x and y are not the same device, or device x and y belong to the same unknown class of devices), and/or (b) identification as in establishing known class membership, e.g., “typing” (e.g. device x belongs to the same class of devices as device y, or device x does not belong to the same class of devices as device y where device y is of a known class of device).

By fingerprinting the client device using the channel characteristics of one or more particular wireless communications, the access point may leverage improved device typing that does not rely on a MAC address or any other explicit information transmitted by the client device (thus avoiding issues of spoofed, obfuscated or corrupted information). Device typing can be used for improved security of the network, business analytics, data analytics, network forensics, among other uses or any combination thereof. Accordingly, the device fingerprint(s) may be used in applications such as dispute resolution (e.g. as evidence in legal proceedings or in insurance investigations, etc.), for business analytics (e.g. forecasting or analyzing market behavior in terms of product adoption), network/services customizations (e.g., bandwidth allocation, traffic prioritization, anonymous session persistence enabling a “guest” or “anonymous” user to create persistent settings tied to an electronic device via a stored device profile, etc.) among other applications or any combination thereof.

Moreover, the access point may utilize legitimate traffic without disrupting the normal operation/communication and thus preserving the quality of service while concurrently providing the improved security. Additionally, the fingerprinting and device typing benefits from low sampling overhead and high signature fidelity (by the virtue of relying on a repeatable and idiosyncratic computation). Indeed, extracting device fingerprinting using channel characteristics is highly correlative to device hardware.

Based on such technical features, further technical benefits become available to users and operators of these systems and methods. Moreover, various practical applications of the disclosed technology are also described, which provide further practical benefits to users and operators that are also new and useful improvements in the art.

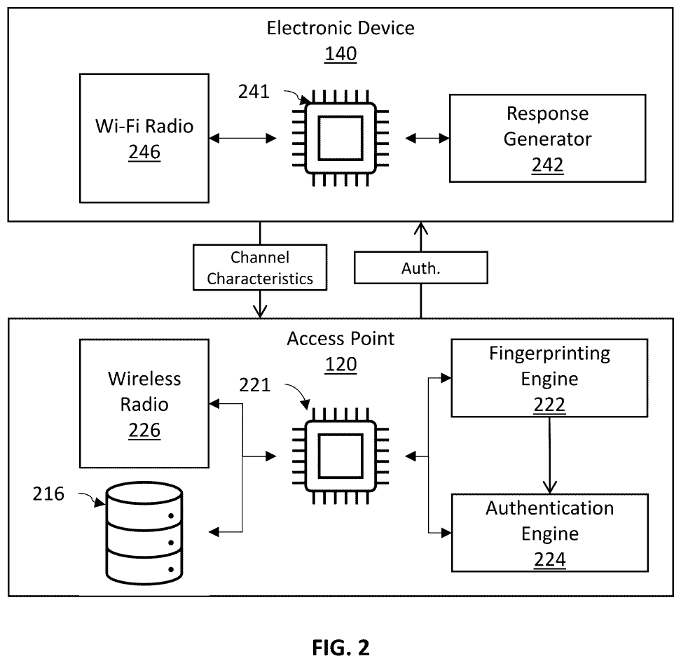

Referring to FIG. 1 and FIG. 2, a wireless networking system using an access point configured to employ channel characteristics of a wireless communication to identify an electronic device is depicted in accordance with one or more embodiments of the present disclosure.

In some embodiments, an electronic device 140 may access a network 101 via an access point 120. In some embodiments, the electronic device 140 may include any device capable of wireless communication with the access point 120. In some embodiments, a connection to the network 101 can be created via the access point 120 of a local wireless network at a location 130. However, network activities and/or online activities (collectively, “network activities”) over the network 101 or on the wireless network of the location 130 may be a target for fraud, hacking and/or spoofing, among other malicious attacks or any combination thereof by bad actors. Unlike in physical activities, the identity of an actor is often difficult to determine because the actor is not actually present for the activity. As a result, a bad actor may attempt to access the access point 120 and/or the network 101 by gaining access using stolen credentials (e.g., a password, username, passkey, one-time password, device identifier (ID), software ID, media access control (MAC) address, or other credential or any combination thereof). Such attacks may be detected and/or prevented using security techniques such as multifactor authentication (MFA), authentication and/or validation of the actor's identity using complex fraud detection and risk evaluation algorithms, biometrics, hardware security keys, cryptographic keys, among other methods. However, such techniques may still be subject to spoofing or man-in-the-middle or other replay attack, resulting in a bad actor gaining access via the access point 120 using stolen information.

In some embodiments, the term “user” may refer to any entity associated with a device, access point 120 and/or distributed wireless communication system, including an individual, a business, commercial organization, a non-profit organization, a public organization (e.g., governmental organization), among other entities or any combination thereof.

In some embodiments, the electronic device 140 may include, e.g., one or more computer devices 142, mobile devices 144, among other devices, including, but not limited to tablets, computers, consumer electronics, home entertainment devices, televisions, IoT devices, or any network-enabled device. For external network connectivity, e.g., via a network 101, one or more of the access points, including the electronic device 140, can be connected to the access point 120, which can be a cable modem, Digital Subscriber Loop (DSL) modem, or any device providing external network connectivity to a physical install location 130 associated with the distributed wireless communication system.

In some embodiments, the network 101 may be associated with one or more physical spaces, such as, e.g., a residential, commercial, merchant, public, or other space or any combination thereof. In some embodiments, the network 101 may include a suitable network type, such as, e.g., a public switched telephone network (PTSN), an integrated services digital network (ISDN), a private branch exchange (PBX), a wireless and/or cellular telephone network, a computer network including a local-area network (LAN), a wide-area network (WAN) or other suitable computer network, or any other suitable network or any combination thereof. In some embodiments, a LAN may connect computers and peripheral devices in a physical area by means of links (wires, Ethernet cables, fiber optics, wireless such as Wi-Fi, etc.) that transmit data. In some embodiments, a LAN may include two or more personal computers, printers, and high-capacity disk-storage devices, file servers, or other devices or any combination thereof. LAN operating system software, which interprets input and instructs networked devices, may enable communication between devices to: share the printers and storage equipment, simultaneously access centrally located processors, data, or programs (instruction sets), and other functionalities. Devices on a LAN may also access other LANs or connect to one or more WANs. In some embodiments, a WAN may connect computers and smaller networks to larger networks over greater geographic areas. A WAN may link the computers by means of cables, optical fibers, or satellites, cellular data networks, or other wide-area connection means. In some embodiments, an example of a WAN may include the Internet.

In some embodiments, the access point 120 may be part of a distributed Wi-Fi system can operate in accordance with the IEEE 802.11 protocols and variations thereof. The distributed wireless communication system includes a plurality of access points, which can be distributed throughout a location, such as a residence, office, or the like. That is, the distributed wireless communication system contemplates operation in any physical location where it is inefficient or impractical to service with a single access point, repeaters, or a mesh system. As described herein, the distributed wireless communication system can be referred to as a network, a system, a Wi-Fi network, a Wi-Fi system, a cloud-based system, etc. The access points can be referred to as nodes, access points, Wi-Fi nodes, Wi-Fi access points, etc. The objective of the access points is to provide network connectivity to the electronic device 140. The electronic device 140 can be referred to as client devices, user devices, clients, Wi-Fi clients, Wi-Fi devices, etc.

In a typical deployment (e.g., in a residential, commercial, merchant, public, or other space or any combination thereof), the distributed wireless communication system can include between 1 to 12 access points or more in a location 130, such as a home. In some embodiments, a large number of access points (which can also be referred to as nodes in the distributed wireless communication system) ensures that the distance between any access point is always small, as is the distance to any electronic device 140 needing Wi-Fi service. That is, an objective of the distributed wireless communication system can be for distances between the access points to be of similar size as distances between the electronic device 140 and the associated access point. Such small distances ensure that every corner of a consumer's home is well covered by Wi-Fi signals. It also ensures that any given hop in the distributed wireless communication system is short and goes through few walls. This results in very strong signal strengths for each hop in the distributed wireless communication system, allowing the use of high data rates, and providing robust operation.

In some embodiments, the access point 120 and/or any access points can include both wireless links, via a radio 226, and wired links for connectivity. In some embodiments, the access point 120 may have a gigabit Ethernet (GbE) wired connection to the network 101 (e.g., via network provider connection such as a telecommunications carrier, fiber and/or cable network operator, etc.). In some embodiments, the access point 120 may also or alternatively have a wired connection and/or wireless connection to the network 101. Similarly, in some embodiments, the electronic device 140 may connect to the network 101 via the access point 120 with one or more wired and/or wireless connections to the access point 120. In some embodiments, the wireless connection(s) may include one or more of Bluetooth™, near-field wireless communication (NFC), RFID, Narrow Band Internet of Things (NBIOT), 3G, 4G, 5G, GSM, GPRS, WiFi, WiMax, CDMA, satellite, ZigBee, Z-Wave, Thread, LoRAN, among others or any combination thereof. In some embodiments, the wired connection(s) may include one or more of Ethernet, universal serial bus (USB), coaxial cable, fiber optic cabling, PCI express, small computer system interface (SCSI), parallel AT attachment (PATA), serial AT attachment (SATA), HyperTransport™, InfiniBand™, Wishbone, Compute Express Link (CXL), among others or any combination thereof.

In some embodiments, the access point 120 may build and/or maintain profiles, in a database 216, of each device and/or device type authenticated for connecting to the network 101 via the access point 120 or via another access point, including a profile for the access point 120 itself. In some embodiments, such profiles of authenticated devices may include user and/or device data including, e.g., device identifier (ID), a media access control (MAC) address, Internet protocol (IP) address, device location, address and/or zip code associated with the install location 130, address and/or zip code provided by an Internet service provider or other network operator or any combination thereof, a device state (e.g., on/off, connected/disconnected, etc.), performance state (e.g., signal strength of wireless communications associated with the access point 120, distance from the access point 120, etc.) among other data and/or attributes associated with the electronic device 140 and/or the access point 120 or any combination thereof. In some embodiments, the profiles may also include data related to the channel characteristics associated with a wireless communication emitted by the electronic device 140 and received by the access point 120.

Herein, the term “database” refers to an organized collection of data, stored, accessed or both electronically from a computer system. The database may include a database model formed by one or more formal design and modeling techniques. The database model may include, e.g., a navigational database, a hierarchical database, a network database, a graph database, an object database, a relational database, an object-relational database, an entity-relationship database, an enhanced entity-relationship database, a document database, an entity-attribute-value database, a star schema database, or any other suitable database model and combinations thereof. For example, the database may include database technology such as, e.g., a centralized or distributed database, cloud storage platform, decentralized system, server or server system, among other storage systems. In some embodiments, the database may, additionally or alternatively, include one or more data storage devices such as, e.g., a hard drive, solid-state drive, flash drive, or other suitable storage device. In some embodiments, the database may, additionally or alternatively, include one or more temporary storage devices such as, e.g., a random-access memory, cache, buffer, or other suitable memory device, or any other data storage solution and combinations thereof.

In some embodiments, the database 216 may be local to the access point 120 or in communication with the access point 120 via the local wireless network at the location 130. In some embodiments, the database 216 may be located external to the local wireless network, such as on the network 101 such that the access point 120 may query the database 216 across the network 101, e.g., via a computer interface. In some embodiments, the one or more computer interfaces may utilize one or more software computing interface technologies, such as, e.g., Common Object Request Broker Architecture (CORBA), an application programming interface (API) and/or application binary interface (ABI), among others or any combination thereof. In some embodiments, an API and/or ABI defines the kinds of calls or requests that can be made, how to make the calls, the data formats that should be used, the conventions to follow, among other requirements and constraints. An “application programming interface” or “API” can be entirely custom, specific to a component, or designed based on an industry-standard to ensure interoperability to enable modular programming through information hiding, allowing users to use the interface independently of the implementation. In some embodiments, CORBA may normalize the method-call semantics between application objects residing either in the same address-space (application) or in remote address-spaces (same host, or remote host on a network).

In some embodiments, the hardware of the electronic device 140 may affect how the electronic device performs computations and generates and transmits wireless communications. As result, hardware variations in electronic devices can result in variations to properties of transmissions across a channel of a communication link, or in the communication link itself. For example, a radio 246 of an electronic device 140 that include radio circuitry such as a processor 241, transceiver, transmitter, receiver, hardware-accelerated encoder/decoder/codec, modulator, oscillator, amplifier, antenna tuner, antenna or any combination thereof. The particular combination of elements of the radio circuitry may result in unique properties of transmitted signals. Indeed, even for a software-defined radio 246, where circuit elements such as the transmitter/transceiver/receiver, modulator, oscillator, amplifier, antenna tuner, etc. are replaced with a processor 241 device having software-defined radio elements, the processor 241 device may produce unique properties as a result of the particular design and configuration of the processor 241 device. Thus, a model or type of the electronic device 140 may be associated with a particular characteristic or characteristics of a particular signal over a channel of the local wireless network.

In some embodiments, the channel characteristics associated with a signal of a communication to the access point 120 may also depend on the processing performed to create the communication, e.g., the data carried by the signal associated with the communication. As a result, identifying a device or device type based on characteristics can be enabled and/or improved by controlling for the type of processing used by the electronic device 140 to produce the communication.

As a result, in some embodiments, the access point 120 and the authentication server 110 may include processor 221 and processor 211, respectively, that are configured to use the channel characteristics associated with a particular communication from the electronic device 140. In some embodiments, the computations involved in generating the data of the communications are consistent or similar, within a degree of tolerance, across attempts by every electronic device 140 to gain access to the access point 120. In some embodiments, the degree of tolerance may be derived from statistical modelling and machine learning modelling using historic or past devices of known identities and/or classes. Thus, data from previous interactions with electronic devices may be aggregated and used to formulate the relationship between the channel characteristics and the device and/or device type, e.g., using one or more statistical and/or machine learning techniques.

As a result, any deviations in channel characteristics of the communication can be correlated to differences in the hardware performing the computations. In some embodiments, the particular communication may be a response to particular request from the access point 120, such as a response to a request for authentication during a device authentication process when the electronic device 140 is attempting to join the local wireless network, such as, e.g., signing on to a Wi-Fi network associated with the access point 120.

In some embodiments, for an 802.11 capable device (e.g., a Wi-Fi enabled device), a communication from an 802.11 capable access point may include an authentication challenge soliciting the electronic device 140 to return a response including access credentials in order so as to authenticate the electronic device 140 and join the local wireless network. In some embodiments, the access point 120 may perform the device authentication to authenticate the electronic device 140, such as when using, without limitation, an open authentication protocol, an EAP four way handshake protocol, shared key authentication protocol, MAC address authentication, among others or any combination thereof. Thus, the access point 120 may issue the authentication challenge communication to the electronic device 140. The response to the authentication challenge is legitimately solicited traffic and thus is sent in the normal course of forming an association between the access point 120 and the electronic device 140. As a result, channel characteristics may be extracted from the response without need for additional transmissions, thus avoiding additional network traffic.

Furthermore, because the response provides credentials to an authentication challenge, the response may include encrypted information according to one or more 802.11-based authentication techniques, such as an open authentication protocol, an EAP four way handshake protocol, shared key authentication protocol, MAC address authentication, among others or any combination thereof. As a result, the electronic device 140 may use a response generator 242 to perform predefined computations to encrypt data as part of the authentication protocol, e.g., as part of key derivation from a shared cryptographic secret, such as a pre-shared key (PSK) or other key derivation for cryptographic authentication between devices. In some embodiments, the response generator 242 may including any combination of software and/or hardware components to perform the predefined computations, such as key derivation or other computations or any combination thereof. Thus, the key derivation provides consistent, controlled conditions for evaluating hardware and hardware variations in generating the response from the electronic device 140.

In some embodiments, the key derivation, among other consistent and controlled calculations, enable the extrapolation of timing-dependent features of resulting transmissions. The extrapolation may be generated based on previously gathered features, e.g., from the same device, so as to establish the identity of the device, transmitter, etc. The extrapolation may be generated based on previously gathered features, e.g., from the same type of device, so as to establish the type of the device, transmitter, etc. In some embodiments, using key derivation or another computation involved in the authentication process may provide additional data. Because the access point 120 is a part of the authentication process, the access point 120 may have privileged access to other information, such as secrets, keys, nonces and other elements used or any combination thereof. In some embodiments, the additional information may be used to capture additional features, such as, without limitation, a ratio of zeros to ones in processed words and/or data, a position or distribution of different bits that may have a direct effect on the switching behavior of the transistors physically realizing the computation which in turn results in nuances in power dissipation and/or timing, among other features or any combination thereof. For example, the power dissipation and/or timing derived from the position or distribution of bits may be reflected in the channel state information, frequency response and/or other measure, and thus may be used to infer additional identifying features of the device.

In some embodiments, the access point 120 is a Wi-Fi access point conforming to the IEEE 802.11 standards, and the electronic device 140 is an 802.11 capable device (e.g., a Wi-Fi enabled device). However, embodiments of the present disclosure apply to other wireless communication standards as well, such as, without limitation, Bluetooth®, ZigBee, Z-Wave, Thread, 6LoWPAN, Radio Frequency Identification (RFID), Near Field Communication (NFC), LoRa, LoRaWAN, Long-Term Evolution (LTE), 5G cellular, among others or any combination thereof.

In some embodiments, the access point 120 may extract the channel characteristics from the signal carrying the response and transmitted by the electronic device 140. In some embodiments, the channel characteristics may be affected by the hardware, including the processing and/or radio hardware, of the electronic device 140, thus producing timing-dependent effects. For example, channel state information, channel frequency response, among other properties and characteristics of the signal may be associated with timing-dependent factors affected by particular hardware characteristics and componentry. Thus, the timing-dependent effects may be extracted and may be unique to a hardware configuration. For example, the access point 120 may perform channel estimation on the channel over which the signal is transmitted to determine, e.g., scattering, fading, power decay, impulse response, fading distribution, channel gain, line-of-sight, spatial correlation, among other properties of the channel and/or signal. Alternatively, or in addition, the access point 120 may measure the magnitude and/or phase of the signal as a function of the frequency of the request communication soliciting the response, thereby extracting the channel frequency response. Other channel characteristics or any combination thereof may also or alternatively be extracted.

In some embodiments, the access point 120 may perform autocorrelation method(s) to remove noise from the channel characteristics, e.g., due to channel perturbation caused by movements. Alternatively, or in addition, the access point 120 may perform cross-correlation and/or phase difference between the channel characteristics of the antenna chains to augment the channel characteristics to reduce environmental dependency of the channel characteristics. In some embodiments, a device or device type fingerprint may be formed from features including one or more of the channel characteristics, the autocorrelation, the cross-correlation and/or the phase difference, among other channel characteristics or any combination thereof.

In some embodiments, the access point 120 may use an authentication engine 224 to perform the device authentication to authenticate the electronic device 140, such as, e.g., in an EAP authentication protocol. Thus, the access point 120 may provide the data of the response (e.g., credentials, identity, device ID, software ID, MAC address, etc.), the channel characteristics and/or the device fingerprint to the authentication server 110 via a connection over the network 101, such as via one or more computer interfaces.

In some embodiments, as depicted in FIG. 2, the access point 120 may receive the data of the response (e.g., credentials, identity, device ID, software ID, MAC address, etc.) and the channel characteristics and generate the fingerprint for the electronic device 140 using a fingerprinting engine 222. In some embodiments, the fingerprint may include a data structure specifying the features of the channel characteristics, individually, as an aggregate (e.g., via algorithmically generated data based on the features, such as a hash), or any combination thereof. In some embodiments, the data structure may include a vector, matrix, list, string, hash, among other data types and/or data structures uniquely representing the features. In some embodiments, the fingerprinting engine 222 may instead or in addition be implemented on the access point 120, thus enabling the access point 120 to provide the fingerprint to the authentication server 110 instead of or in addition to the data of the response (e.g., credentials, identity, device ID, software ID, MAC address, etc.) and the channel characteristics.

In some embodiments, to create a fingerprint for a device, the channel characteristics may undergo feature extraction. Feature extraction may include, e.g., Fourier transform, Z-transform, principal component analysis (PCA), independent subspace analysis (ISA), among others or any combination thereof. In some embodiments, raw channel characteristics, the features extracted from the channel characteristics or a combination thereof, may be assembled into a fingerprint or profile for the device.

In some embodiments, herein the term “engine” or “computer engine” refers to at least one software component and/or a combination of at least one software component and at least one hardware component which are designed/programmed/configured to manage/control other software and/or hardware components (such as the libraries, software development kits (SDKs), objects, etc.).

In some embodiments, the fingerprinting engine 222 and/or the authentication engine 224 may be integrated into the access point 120, or may be remote from the access point 120. For example, the fingerprinting engine 222 and/or the authentication engine 224 may be implemented in a separate device on the local wireless network of the location 130 and may be in communication with the access point 120 via one or more wired and/or wireless connections. Thus, the access point 120 may call the fingerprinting engine 222 and/or the authentication engine 224. Alternatively, or in combination, the fingerprinting engine 222 and/or the authentication engine 224 may be located remotely across the network 101, e.g., in a server or cloud system. Thus, the access point 120 may call the fingerprinting engine 222 and/or the authentication engine 224 as a service via a suitable computer interface across the network 101, such as an API, ABI, CORBA or other interface.

In some embodiments, the access point 120 may analyze the features of the device fingerprint and the data of the response to determine whether to authenticate the electronic device 140. In some embodiments, to do so, the access point 120 may access the device profile in the profile database to determine whether the data and/or the features match the device/device type of a profile. Here, the term “match” refers to two or more items or sets of items being the same or similar within a threshold degree of sufficiency of similarity, as detailed further below. In some embodiments, the access point 120 may determine whether each item of data (e.g., credentials, identity, device ID, software ID, MAC address, etc.) is an exact match to a corresponding item of data in a profile, or whether each data item, alone or in an aggregate is sufficiently similar to data in a profile. Similarly, the features of the device fingerprint, including raw and/or extracted features, may be analyzed relative to the profile database to determine whether each feature is an exact match to a corresponding item of data in a profile, or whether the features, alone or in an aggregate are sufficiently similar to data in a profile.

In some embodiments, upon comparing the fingerprint to the pre-stored fingerprints of known and/or unknown pre-stored device profiles, the electronic device 140 may be identified. Here, the term “identify” refers to determining at least one of: an identity (e.g., a user identity and/or device identifier (ID)) associated with the electronic device 140, or a device type associated with the electronic device 140 (e.g., a class of device, a device model, a device feature set, among others or any combination thereof).

In some embodiments, identification may include, e.g., (a) establishing identity relation, or establishing unknown class membership (e.g., device x and device y are the same device, or device x and y are not the same device, or device x and y belong to the same unknown class of devices), and/or (b) identification as in establishing known class membership, e.g., “typing” (e.g. device x belongs to the same class of devices as device y, or device x does not belong to the same class of devices as device y where device y is of a known class of device). In some embodiments, establishing an identity relation between devices may enable learning of different identities, such as, when two electronic devices advertising the same MAC address are indeed the same device, or that two electronic devices advertising different MACs are actually the same device, etc. In some embodiments, establishing known class membership may enable extrapolating from the channel characteristics collected from different classes of devices (e.g., in the pre-stored device profiles), determining that the electronic device is a device of a certain type.

In some embodiments, sufficiency of similarity may be assessed according to similarity thresholds and a similarity measure between the data and/or features and data in a profile in the profile database. Thus, the access point 120 may measure similarity using one or more similarity measures to determine one or more scores, where if the one or more scores satisfy one or more thresholds, indicates an identification of the electronic device 140. Therefore, based on the similarity to the profile, the access point 120 may assess identity and/or type associated with the electronic device 140. For example, in some embodiments, the access point 120 may produce a binary indication of, e.g., a known or unknown device/device type, match and no match, or other suitable formulation of the response data and/or channel characteristics, among other features, being the same as or different from the profile. In another example, the access point 120 may generate a probability score indicative of a degree of a match to a pre-stored device profile and/or device type based on a degree of similarity between the device fingerprint and the user and/or one or more pre-stored device fingerprints of the profile(s) of known devices/device types. In some embodiments, the similarity may be assessed according to a number of data items that match compared to a number of data items that do not match.

In some embodiments, the similarity between the response data and/or device fingerprint features and the data of the profile and/or whether each data item of the response data and/or device fingerprint features matches a correspond data item of the profile may be measured according to one or more similarity measures. In some embodiments, the measure of similarity may include, e.g., an exact match or a predetermined similarity score according to, e.g., Jaccard similarity, Jaro-Winkler similarity, Cosine similarity, Euclidean similarity, Overlap similarity, Pearson similarity, Approximate Nearest Neighbors, K-Nearest Neighbors, among other similarity measure. The predetermined similarity score may be any suitable similarity score according to the type of electronic activity to identify a measured attribute of any two data entries as the same.

In some embodiments, similarity may be measured between each individual data item separately, and the respective similarity scores summed, averaged, or otherwise combined to produce a measure of similarity between the response data and/or device fingerprint features and the data of the profile. In some embodiments, the similarity may instead or in addition be measured for a combination of the device identifier, device type identifier and location identifier. For example, a hash or group key may be generated by combining the device identifier, device type identifier and location identify. The hash may include a hash functioning take as input each of attribute or a subset of attributes of a particular data entry. The group key may be produced by creating a single string, list, or value from combining each of, e.g., a string, list or value representing each individual attribute of the particular data entry. The similarity between the response data and/or device fingerprint features and the data of the profile may then be measured as the similarity between the associated hashes and/or group keys.

In some embodiments, alternatively or in addition to a similarity measure, the data and/or features may be fed into a model to predict an identification associated with the device based on previous and/or existing fingerprints of known devices. In some embodiments, the model may include a statistical model that determines a probability of the fingerprint being a particular known pre-stored device fingerprint of the profile(s) of known devices/device types. Accordingly, in some embodiments, the statistical model may implement one or more of, e.g., Chi-squared, G-test, Kolmogorov-Smirnov, Anderson-Darling, Lilliefors, Jarque-Bera, Normality (“Shapiro-Wilk”), Likelihood-ratio test, among others or any combination thereof.

In some embodiments, alternatively or in addition to a similarity measure, the data and/or features may be fed into a machine learning model, such as a supervised machine learning model or unsupervised machine learning model. In some embodiments, the inventive computer-based systems/platforms, the inventive computer-based devices, and/or the inventive computer-based components of the present disclosure may be configured to utilize one or more AI/machine learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an neutral network technique may be one of, without limitation, feedforward neural network, radial basis function network, recurrent neural network, convolutional network (e.g., U-net) or other suitable network. In some embodiments and, optionally, in combination of any embodiment described above or below, an implementation of supervised machine learning model may be executed as follows:
a. define supervised machine learning model architecture/model,
b. transfer the input data to the supervised machine learning model,
c. train the supervised machine learning model incrementally,
d. determine the accuracy for a specific number of timesteps,
c. apply the trained supervised machine learning model to process the newly-received input data,
f. optionally and in parallel, continue to train the trained supervised machine learning model with a predetermined periodicity.

In some embodiments and, optionally, in combination of any embodiment described above or below, the trained supervised machine learning model may specify a model architecture including the parameters and/or hyperparameters thereof. For example, the topology of a supervised machine learning model may include a configuration of nodes of a neural network and connections between such nodes. In some embodiments and, optionally, in combination of any embodiment described above or below, the trained supervised machine learning model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, etc.) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In some embodiments, the parameters of the machine learning model may be trained based on known outputs. For example, the fingerprint of the electronic device 140 may be paired with a target classification or known classification to form a training pair, such as a historical fingerprint of the electronic device 140 and an observed result and/or human annotated classification denoting whether the historical fingerprint of the electronic device 140 is a matching pre-stored device fingerprint. In some embodiments, the fingerprint of the electronic device 140 may be provided to the machine learning model, e.g., encoded in a feature vector, to produce a predicted label. In some embodiments, an optimizer associated with the machine learning model may then compare the predicted label with the known output of a training pair including the historical fingerprint of the electronic device 140 to determine an error of the predicted label. In some embodiments, the optimizer may employ a loss function, such as, e.g., Hinge Loss, Multi-class SVM Loss, Cross Entropy Loss, Negative Log Likelihood, or other suitable classification loss function to determine the error of the predicted label based on the known output.

In some embodiments, the known output may be obtained after the machine learning model produces the prediction, such as in online learning scenarios. In such a scenario, the machine learning model may receive the fingerprint of the electronic device 140 and generate the model output vector to produce a label classifying the fingerprint of the electronic device 140. Subsequently, a user may provide feedback by, e.g., modifying, adjusting, removing, and/or verifying the label via a suitable feedback mechanism, such as a user interface device (e.g., keyboard, mouse, touch screen, user interface, or other interface mechanism of a user device or any suitable combination thereof). The feedback may be paired with the fingerprint of the electronic device 140 to form the training pair and the optimizer may determine an error of the predicted label using the feedback.

In some embodiments, based on the error, the optimizer may update the parameters of the machine learning model using a suitable training algorithm such as, e.g., backpropagation for a classifier machine learning model. In some embodiments, backpropagation may include any suitable minimization algorithm such as a gradient method of the loss function with respect to the weights of the classifier machine learning model. Examples of suitable gradient methods include, e.g., stochastic gradient descent, batch gradient descent, mini-batch gradient descent, or other suitable gradient descent technique. As a result, the optimizer may update the parameters of the machine learning model based on the error of predicted labels in order to train the machine learning model to model the correlation between fingerprint of the electronic device 140 and a matching pre-stored device fingerprint in order to produce more accurate labels of fingerprint of the electronic device 140.

In some embodiments, the identification of the electronic device 140 may then be used to improve the operation of the network. For example, the access point 120 may optimize network bandwidth by increasing and/or decreasing a number of bands reserved for the electronic device 140 based on the type of device. For example, a gaming console may require greater bandwidth than an e-reader device.

In some embodiments, the access point 120 may use the identification of the device and/or device type to improve security on the network, such as by determining authentication of the electronic device 140 for signing onto the network or a risk score indicative of a risk of fraud in the electronic device 140 attempting to logon on the network. In some embodiments, the risk score and/or binary risk label may be determined based on the similarity measure. In some embodiments, the risk score and/or binary risk label may be formulated by one or more risk algorithms, including machine learning models, such as, e.g., a logic rules-based algorithm, a convolutional neural network (CNN), recurrent neural network (RNN), generative adversarial network (GAN), a Naive Bayes classifier, decision trees, random forest, support vector machine (SVM), K-Nearest Neighbors, or any other machine learning model or any combination thereof.

In some embodiments, the risk algorithm(s) may use the similarity measure as input as well as one or more additional data items. For example, a device state and/or performance data associated with the electronic device 140 and/or the access point 120 may be indicative of whether the electronic device 140 was actually used to create the response communication as opposed to a fraudulent or spoofed network activity communication, such as, e.g., using a man-in-the-middle attack.

In some embodiments, based on the authenticity determination of the authentication engine 224 associated with the response data and/or device fingerprint features, the access point 120 may authorize or reject access by the electronic device 140 based on the risk score/label.

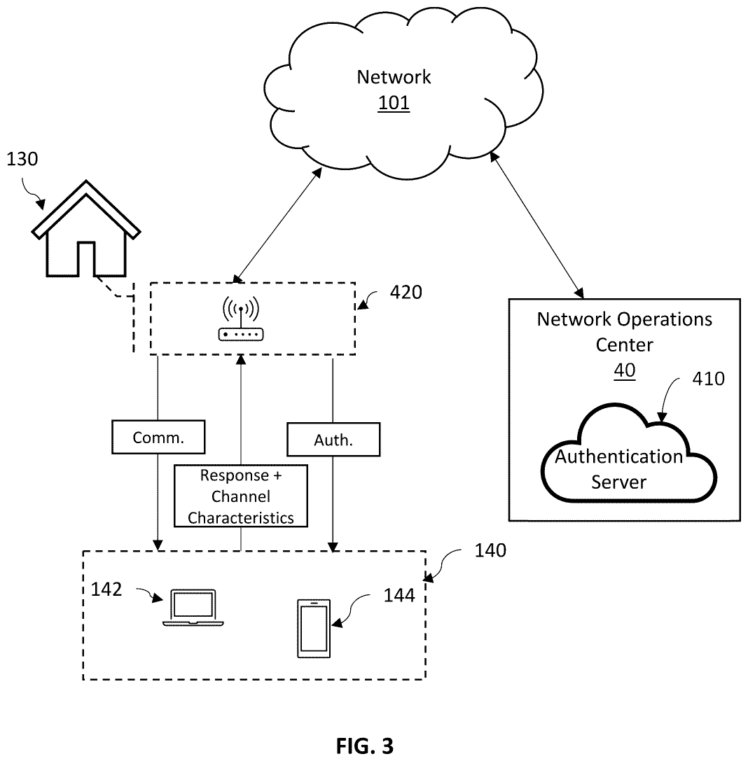

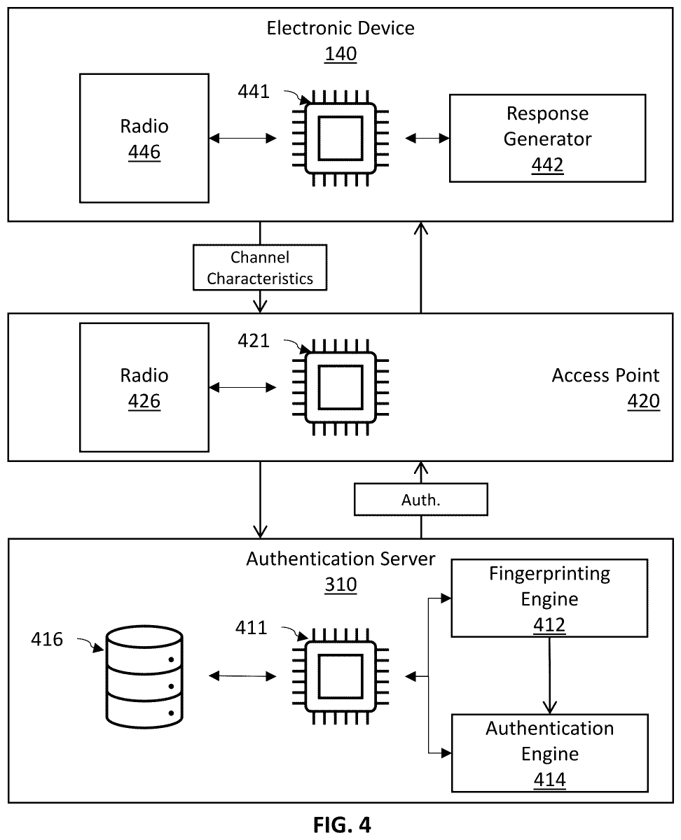

Referring to FIG. 3 and FIG. 4, a wireless networking system using an access point and an authentication server, the wireless networking system configured to employ channel characteristics of a wireless communication to authenticate an electronic device is depicted in accordance with one or more embodiments of the present disclosure.

In some embodiments, a connection to the network 101 can be created via an access point 320 of a local wireless network at a location 130. However, network activities and/or online activities (collectively, “network activities”) over the network 101 or on the wireless network of the location 130 may be a target for fraud, hacking and/or spoofing, among other malicious attacks or any combination thereof by bad actors. Unlike in physical activities, the identity of an actor is often difficult to determine because the actor is not actually present for the activity. As a result, a bad actor may attempt to access the access point 320 and/or the network 101 by gaining access using stolen credentials (e.g., a password, username, passkey, one-time password, device identifier (ID), software ID, media access control (MAC) address, or other credential or any combination thereof). Such attacks may be detected and/or prevented using security techniques such as multifactor authentication (MFA), authentication and/or validation of the actor's identity using complex fraud detection and risk evaluation algorithms, biometrics, hardware security keys, cryptographic keys, among other methods. However, such techniques may still be subject to spoofing or man-in-the-middle or other replay attack, resulting in a bad actor gaining access via the access point 320 using stolen information.

In some embodiments, the term “user” may refer to any entity associated with a device, access point 320 and/or distributed wireless communication system, including an individual, a business, commercial organization, a non-profit organization, a public organization (e.g., governmental organization), among other entities or any combination thereof.

In some embodiments, the electronic device 140 may include, e.g., one or more computer devices 142, mobile devices 144, among other devices, including, but not limited to tablets, computers, consumer electronics, home entertainment devices, televisions, IoT devices, or any network-enabled device. For external network connectivity, e.g., via a network 101, one or more of the access points, including the electronic device 140, can be connected to an access point 320, which can be a cable modem, Digital Subscriber Loop (DSL) modem, or any device providing external network connectivity to a physical install location 130 associated with the distributed wireless communication system.

In some embodiments, the network 101 may be associated with one or more physical spaces, such as, e.g., a residential, commercial, merchant, public, or other space or any combination thereof. In some embodiments, the network 101 may include a suitable network type, such as, e.g., a public switched telephone network (PTSN), an integrated services digital network (ISDN), a private branch exchange (PBX), a wireless and/or cellular telephone network, a computer network including a local-area network (LAN), a wide-area network (WAN) or other suitable computer network, or any other suitable network or any combination thereof. In some embodiments, a LAN may connect computers and peripheral devices in a physical area by means of links (wires, Ethernet cables, fiber optics, wireless such as Wi-Fi, etc.) that transmit data. In some embodiments, a LAN may include two or more personal computers, printers, and high-capacity disk-storage devices, file servers, or other devices or any combination thereof. LAN operating system software, which interprets input and instructs networked devices, may enable communication between devices to: share the printers and storage equipment, simultaneously access centrally located processors, data, or programs (instruction sets), and other functionalities. Devices on a LAN may also access other LANs or connect to one or more WANs. In some embodiments, a WAN may connect computers and smaller networks to larger networks over greater geographic areas. A WAN may link the computers by means of cables, optical fibers, or satellites, cellular data networks, or other wide-area connection means. In some embodiments, an example of a WAN may include the Internet.

In some embodiments, a network operations center 30 may use an authentication server 310 to verify and authenticate the user and/or the electronic device 140 for access to the access point 320 based on channel characteristics associated with a channel of the local wireless network on which the electronic device 140 communicates with the access point 320.

In some embodiments, the access point 320 may be part of a distributed Wi-Fi system can operate in accordance with the IEEE 802.11 protocols and variations thereof. The distributed wireless communication system includes a plurality of access points, which can be distributed throughout a location, such as a residence, office, or the like. That is, the distributed wireless communication system contemplates operation in any physical location where it is inefficient or impractical to service with a single access point, repeaters, or a mesh system. As described herein, the distributed wireless communication system can be referred to as a network, a system, a Wi-Fi network, a Wi-Fi system, a cloud-based system, etc. The access points can be referred to as nodes, access points, Wi-Fi nodes, Wi-Fi access points, etc. The objective of the access points is to provide network connectivity to the electronic device 140. The electronic device 140 can be referred to as client devices, user devices, clients, Wi-Fi clients, Wi-Fi devices, etc.

In a typical deployment (e.g., in a residential, commercial, merchant, public, or other space or any combination thereof), the distributed wireless communication system can include between 3 to 12 access points or more in a location 130, such as a home. In some embodiments, a large number of access points (which can also be referred to as nodes in the distributed wireless communication system) ensures that the distance between any access point is always small, as is the distance to any electronic device 140 needing Wi-Fi service. That is, an objective of the distributed wireless communication system can be for distances between the access points to be of similar size as distances between the electronic device 140 and the associated access point. Such small distances ensure that every corner of a consumer's home is well covered by Wi-Fi signals. It also ensures that any given hop in the distributed wireless communication system is short and goes through few walls. This results in very strong signal strengths for each hop in the distributed wireless communication system, allowing the use of high data rates, and providing robust operation.

In some embodiments, while providing excellent coverage, a large number of access points (nodes) presents a coordination problem. Getting all the access points configured correctly and communicating efficiently requires centralized control. In some embodiments, the network operations center 30 may provide control that can be reached across the network 101 and accessed remotely, such as through an application (“app”) running on the electronic device 140. The running of the distributed wireless communication system, therefore, becomes what is commonly known as a “cloud service.” In some embodiments, the network operations center 30 may be configured to receive measurement data, to analyze the measurement data, and to configure the access points in the distributed wireless communication system based thereon, through the network operations center 30. In some embodiments, the network operations center 30 may also be configured to determine which access point each of the electronic device 140 connect (associate) with. That is, in an example aspect, the distributed wireless communication system includes cloud-based control (with a cloud-based controller or cloud service in the cloud) to optimize, configure, and monitor the operation of the access points and the electronic device 140. This cloud-based control is contrasted with a conventional operation that relies on a local configuration, such as by logging in locally to an access point. In the distributed wireless communication system, the control and optimization may be effectuated by logging into the electronic device 140 (or a local electronic device 140) communicating with the network operations center 30 cloud, such as via a disparate network (a different network than the distributed wireless communication system) (e.g., LTE, another Wi-Fi network, etc.).

In some embodiments, the access point 320 and/or any access points can include both wireless links, via a radio 426, and wired links for connectivity. In some embodiments, the access point 320 may have a gigabit Ethernet (GbE) wired connection to the network 101 (e.g., via network provider connection such as a telecommunications carrier, fiber and/or cable network operator, etc.). In some embodiments, the access point 320 may also or alternatively have a wired connection and/or wireless connection to the network 101. Similarly, in some embodiments, the electronic device 140 may connect to the network 101 via the access point 320 with one or more wired and/or wireless connections to the access point 320. In some embodiments, the wireless connection(s) may include one or more of Bluetooth™, near-field wireless communication (NFC), RFID, Narrow Band Internet of Things (NBIOT), 3G, 3G, 5G, GSM, GPRS, WiFi, WiMax, CDMA, satellite, ZigBee, Z-Wave, Thread, LoRAN, among others or any combination thereof. In some embodiments, the wired connection(s) may include one or more of Ethernet, universal serial bus (USB), coaxial cable, fiber optic cabling, PCI express, small computer system interface (SCSI), parallel AT attachment (PATA), serial AT attachment (SATA), HyperTransport™, InfiniBand™, Wishbone, Compute Express Link (CXL), among others or any combination thereof.

In some embodiments, the network operations center 30 may configure or otherwise manage the distributed wireless communication system, including the access point 320 and/or the electronic device 140 via cloud-based management. In some embodiments, the configuration may be through a software agent installed in each device or the like, e.g., OpenSync. As described herein, cloud-based management includes reporting of wireless communication-related performance metrics to the network operations center 30 as well as receiving wireless communication-related configuration parameters from the network operations center 30. The systems and methods contemplate use with any wireless communication system, such as, e.g., a Wi-Fi system (e.g., the distributed wireless communication system, a single access point system, a Wi-Fi mesh network, a Wi-Fi repeater network, among others or any combination thereof), including systems that only support reporting of Wi-Fi related performance metrics (and not supporting cloud-based configuration).

In some embodiments, through management of the access point 320, the network operations center 30 may build and/or maintain profiles, in a database 416, of each device and/or device type authenticated for connecting to the network 101 via the access point 320 or via another access point, including a profile for the access point 320 itself. In some embodiments, such profiles of authenticated devices may include user and/or device data including, e.g., device identifier (ID), a media access control (MAC) address, Internet protocol (IP) address, device location, address and/or zip code associated with the install location 130, address and/or zip code provided by an Internet service provider or other network operator or any combination thereof, a device state (e.g., on/off, connected/disconnected, etc.), performance state (e.g., signal strength of wireless communications associated with the access point 320, distance from the access point 320, etc.) among other data and/or attributes associated with the electronic device 140 and/or the access point 320 or any combination thereof. In some embodiments, the profiles may also include data related to the channel characteristics associated with a wireless communication emitted by the electronic device 140 and received by the access point 320.

Herein, the term “database” refers to an organized collection of data, stored, accessed or both electronically from a computer system. The database may include a database model formed by one or more formal design and modeling techniques. The database model may include, e.g., a navigational database, a hierarchical database, a network database, a graph database, an object database, a relational database, an object-relational database, an entity-relationship database, an enhanced entity-relationship database, a document database, an entity-attribute-value database, a star schema database, or any other suitable database model and combinations thereof. For example, the database may include database technology such as, e.g., a centralized or distributed database, cloud storage platform, decentralized system, server or server system, among other storage systems. In some embodiments, the database may, additionally or alternatively, include one or more data storage devices such as, e.g., a hard drive, solid-state drive, flash drive, or other suitable storage device. In some embodiments, the database may, additionally or alternatively, include one or more temporary storage devices such as, e.g., a random-access memory, cache, buffer, or other suitable memory device, or any other data storage solution and combinations thereof.

In some embodiments, the hardware of the electronic device 140 may affect how the electronic device performs computations and generates and transmits wireless communications, leading to the timing-dependent effects on the channel. As result, hardware variations in electronic devices can result in variations to properties of transmissions across a channel of a communication link, or in the communication link itself. For example, a radio 446 of an electronic device 140 that include radio circuitry such as a processor 441, transceiver, transmitter, receiver, hardware-accelerated encoder/decoder/codec, modulator, oscillator, amplifier, antenna tuner, antenna or any combination thereof. The particular combination of elements of the radio circuitry may result in unique properties of transmitted signals. Indeed, even for a software-defined radio 446, where circuit elements such as the transmitter/transceiver/receiver, modulator, oscillator, amplifier, antenna tuner, etc. are replaced with a processor 441 device having software-defined radio elements, the processor 441 device may produce unique properties as a result of the particular design and configuration of the processor 441 device. Thus, a model or type of the electronic device 140 may be associated with a particular characteristic or characteristics of a particular signal over a channel of the local wireless network.

In some embodiments, the channel characteristics associated with a signal of a communication to the access point 320 may also depend on the processing performed to create the communication, e.g., the data carried by the signal associated with the communication. As a result, identifying a device or device type based on characteristics can be enabled and/or improved by controlling for the type of processing used by the electronic device 140 to produce the communication.

As a result, in some embodiments, the access point 320 and the authentication server 310 may include processor 421 and processor 411, respectively, that are configured to use the channel characteristics associated with a particular communication from the electronic device 140 that is similar, within a degree of tolerance, across attempts by every electronic device 140 to gain access to the access point 320. In some embodiments, the degree of tolerance may be derived from statistical modelling and machine learning modelling using historic or past devices of known identities and/or classes. Thus, data from previous interactions with electronic devices may be aggregated and used to formulate the relationship between the channel characteristics and the device and/or device type, e.g., using one or more statistical and/or machine learning techniques. In some embodiments, the particular communication may be a response to particular request from the access point 320, such as a response to a request for authentication during a device authentication process when the electronic device 140 is attempting to join the local wireless network, such as, e.g., signing on to a Wi-Fi network associated with the access point 320.

In some embodiments, for an 802.11 capable device (e.g., a Wi-Fi enabled device), a communication from an 802.11 capable access point may include an authentication challenge soliciting the electronic device 140 to return a response including access credentials in order so as to authenticate the electronic device 140 and join the local wireless network. In some embodiments, the authentication server 310 of the network operations center 30 may perform the device authentication to authenticate the electronic device 140, such as, e.g., in an EAP authentication protocol. Thus, the authentication challenge may originate from the authentication server 310 and be provided to the access point 320 via the network 101 so that the access point 320 may issue the authentication challenge communication to the electronic device 140. The response to the authentication challenge is legitimately solicited traffic and thus is sent in the normal course of forming an association between the access point 320 and the electronic device 140. As a result, channel characteristics may be extracted from the response without need for additional transmissions, thus avoiding additional network traffic.

Furthermore, because the response provides credentials to an authentication challenge, the response may include encrypted information according to one or more 802.11-based authentication techniques, such as extensible authentication protocol (EAP) authentication, or other suitable authentication protocol. As a result, the electronic device 140 may use a response generator 442 to perform predefined computations to encrypt data as part of the authentication protocol, e.g., as part of EAP key derivation from a pre-shared key (PSK) or other key derivation for cryptographic authentication between devices. In some embodiments, the response generator 442 may including any combination of software and/or hardware components to perform the predefined computations, such as key derivation or other computations or any combination thereof. Thus, the key derivation provides consistent, controlled conditions for evaluating hardware and hardware variations in generating the response from the electronic device 140.

In some embodiments, the access point 320 is a Wi-Fi access point conforming to the IEEE 802.11 standards, and the electronic device 140 is an 802.11 capable device (e.g., a Wi-Fi enabled device). However, embodiments of the present disclosure apply to other wireless communication standards as well, such as, without limitation, Bluetooth®, ZigBee, Z-Wave, Thread, 6LoWPAN, Radio Frequency Identification (RFID), Near Field Communication (NFC), LoRa, LoRaWAN, Long-Term Evolution (LTE), 5G cellular, among others or any combination thereof.

In some embodiments, the access point 320 may extract the channel characteristics from the signal carrying the response and transmitted by the electronic device 140. In some embodiments, the channel characteristics may be affected by the hardware, including the processing and/or radio hardware, of the electronic device 140. For example, channel state information, channel frequency response, among other properties and characteristics of the signal may be extracted and may be unique to a hardware configuration. For example, the access point 320 may perform channel estimation on the channel over which the signal is transmitted to determine, e.g., scattering, fading, power decay, impulse response, fading distribution, channel gain, line-of-sight, spatial correlation, among other properties of the channel and/or signal. Alternatively, or in addition, the access point 320 may measure the magnitude and/or phase of the signal as a function of the frequency of the request communication soliciting the response, thereby extracting the channel frequency response. Other channel characteristics or any combination thereof may also or alternatively be extracted.

In some embodiments, the access point 320 may perform autocorrelation method(s) to remove noise from the channel characteristics, e.g., due to channel perturbation caused by movements. Alternatively, or in addition, the access point 320 may perform cross-correlation and/or phase difference between the channel characteristics of the antenna chains to augment the channel characteristics to reduce environmental dependency of the channel characteristics. In some embodiments, a device or device type fingerprint may be formed from features including one or more of the channel characteristics, the autocorrelation, the cross-correlation and/or the phase difference, among other channel characteristics or any combination thereof.

In some embodiments, the authentication server 310 of the network operations center 30 may use an authentication engine 414 to perform the device authentication to authenticate the electronic device 140, such as, e.g., in an EAP authentication protocol. Thus, the access point 320 may provide the data of the response (e.g., credentials, identity, device ID, software ID, MAC address, etc.), the channel characteristics and/or the device fingerprint to the authentication server 310 via a connection over the network 101, such as via one or more computer interfaces. In some embodiments, the one or more computer interfaces may utilize one or more software computing interface technologies, such as, e.g., Common Object Request Broker Architecture (CORBA), an application programming interface (API) and/or application binary interface (ABI), among others or any combination thereof. In some embodiments, an API and/or ABI defines the kinds of calls or requests that can be made, how to make the calls, the data formats that should be used, the conventions to follow, among other requirements and constraints. An “application programming interface” or “API” can be entirely custom, specific to a component, or designed based on an industry-standard to ensure interoperability to enable modular programming through information hiding, allowing users to use the interface independently of the implementation. In some embodiments, CORBA may normalize the method-call semantics between application objects residing either in the same address-space (application) or in remote address-spaces (same host, or remote host on a network).

In some embodiments, as depicted in FIG. 4, the authentication server 310 may receive the data of the response (e.g., credentials, identity, device ID, software ID, MAC address, etc.) and the channel characteristics from the access point 420, and generate the fingerprint for the electronic device 140 using a fingerprinting engine 412, e.g., as detailed above. In some embodiments, the fingerprint may include a data structure specifying the features of the channel characteristics, individually, as an aggregate (e.g., via algorithmically generated data based on the features, such as a hash), or any combination thereof. In some embodiments, the data structure may include a vector, matrix, list, string, hash, among other data types and/or data structures uniquely representing the features. In some embodiments, the fingerprinting engine 412 may instead or in addition be implemented on the access point 420, thus enabling the access point 420 to provide the fingerprint to the authentication server 310 instead of or in addition to the data of the response (e.g., credentials, identity, device ID, software ID, MAC address, etc.) and the channel characteristics.

In some embodiments, herein the term “engine” or “computer engine” refers to at least one software component and/or a combination of at least one software component and at least one hardware component which are designed/programmed/configured to manage/control other software and/or hardware components (such as the libraries, software development kits (SDKs), objects, etc.).

In some embodiments, the authentication server 310 may analyze the features of the device fingerprint and the data of the response to determine whether to authenticate the electronic device 140. In some embodiments, to do so, the authentication server 310 may access the device profile in the profile database to determine whether the data and/or the features match the device/device type of a profile. In some embodiments, the authentication server 310 may determine whether each item of data (e.g., credentials, identity, device ID, software ID, MAC address, etc.) is an exact match to a corresponding item of data in a profile, or whether each data item, alone or in an aggregate is sufficiently similar to data in a profile. Similarly, the features of the device fingerprint may be analyzed relative to the profile database to determine whether each feature is an exact match to a corresponding item of data in a profile, or whether each feature, alone or in an aggregate is sufficiently similar to data in a profile.

In some embodiments, sufficiency of similarity may be assessed according to similarity thresholds and a similarity measure between the data and/or features and data in a profile in the profile database. Thus, the authentication server 310 may measure similarity using one or more similarity measures to determine one or more scores, where if the one or more scores satisfy one or more thresholds, indicates authenticity of the electronic device 140. Therefore, based on the similarity to the profile, the authentication server 310 may assess authenticity and/or risk of fraud associated with the electronic device 140. For example, in some embodiments, the authentication server 310 may produce a binary indication of, e.g., high risk and low risk, fraud likely and fraud unlikely, confirm and deny, match and no match, or other suitable formulation of the response data and/or channel characteristics, among other features, being the same as or different from the profile. In another example, the authentication server 310 may generate a risk score indicative of a degree of risk of fraud based on a degree of similarity between the device fingerprint and the user and/or one or more pre-stored device fingerprints of the profile(s) of known devices/device types. In some embodiments, the similarity may be assessed according to a number of data items that match compared to a number of data items that do not match.

In some embodiments, the similarity between the response data and/or device fingerprint features and the data of the profile and/or whether each data item of the response data and/or device fingerprint features matches a correspond data item of the profile may be measured according to one or more similarity measures. In some embodiments, the measure of similarity may include, e.g., an exact match or a predetermined similarity score according to, e.g., Jaccard similarity, Jaro-Winkler similarity, Cosine similarity, Euclidean similarity, Overlap similarity, Pearson similarity, Approximate Nearest Neighbors, K-Nearest Neighbors, among other similarity measure. The predetermined similarity score may be any suitable similarity score according to the type of electronic activity to identify a measured attribute of any two data entries as the same.

In some embodiments, similarity may be measured between each individual data item separately, and the respective similarity scores summed, averaged, or otherwise combined to produce a measure of similarity between the response data and/or device fingerprint features and the data of the profile. In some embodiments, the similarity may instead or in addition be measured for a combination of the device identifier, device type identifier and location identifier. For example, a hash or group key may be generated by combining the device identifier, device type identifier and location identify. The hash may include a hash functioning take as input each of attribute or a subset of attributes of a particular data entry. The group key may be produced by creating a single string, list, or value from combining each of, e.g., a string, list or value representing each individual attribute of the particular data entry. The similarity between the response data and/or device fingerprint features and the data of the profile may then be measured as the similarity between the associated hashes and/or group keys.

In some embodiments, the risk score and/or binary risk label may be determined based on the similarity measure. In some embodiments, the risk score and/or binary risk label may be formulated by one or more risk algorithms, including machine learning models, such as, e.g., a logic rules-based algorithm, a convolutional neural network (CNN), recurrent neural network (RNN), generative adversarial network (GAN), a Naive Bayes classifier, decision trees, random forest, support vector machine (SVM), K-Nearest Neighbors, or any other machine learning model or any combination thereof.

In some embodiments, the risk algorithm(s) may use the similarity measure as input as well as one or more additional data items. For example, a device state and/or performance data associated with the electronic device 140 and/or the access point 420 may be indicative of whether the electronic device 140 was actually used to create the response communication as opposed to a fraudulent or spoofed network activity communication, such as, e.g., using a man-in-the-middle attack.

In some embodiments, upon determining the risk, the authentication server 310 may provide the risk score and/or risk label to the access point 420 associated with the network activity. In some embodiments, the access point 420 may query the authentication server 310 via the one or more computer interfaces. Accordingly, in some embodiments, based on the authenticity determination of the authentication server 310 associated with the response data and/or device fingerprint features, the access point 420 may authorize or reject access by the electronic device 140 based on the risk score/label.

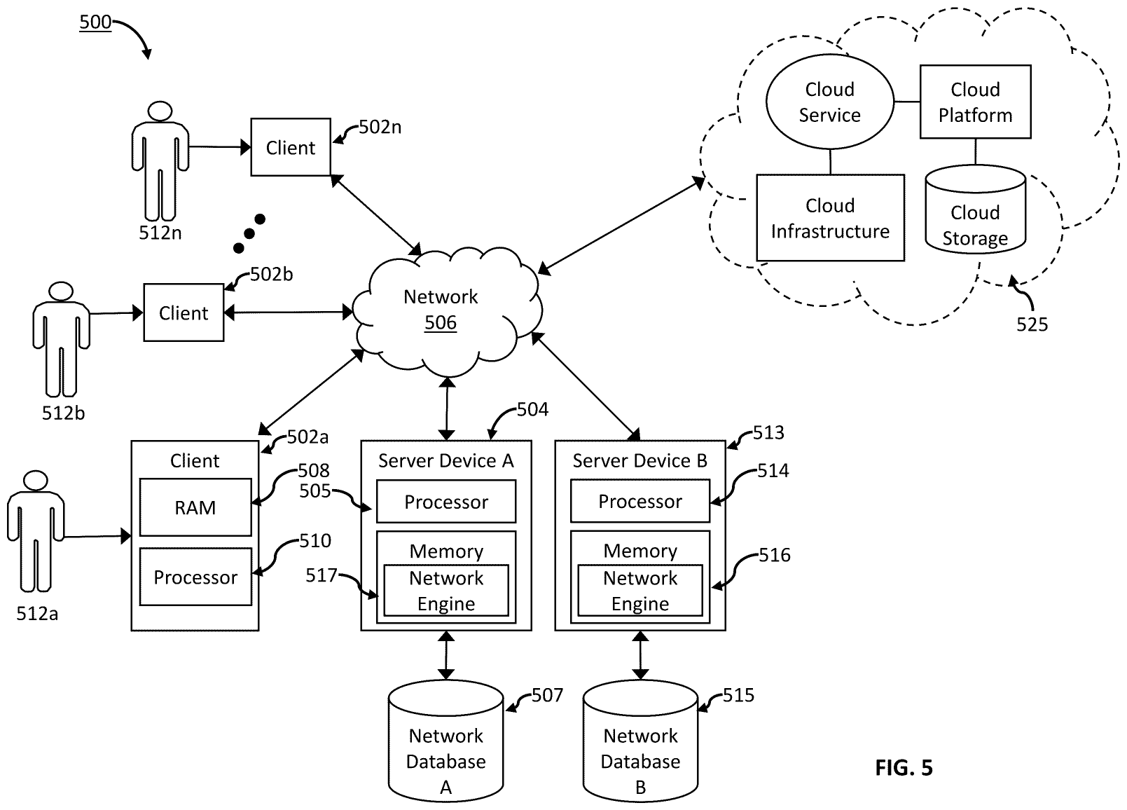

FIG. 5 depicts a block diagram of another computer-based system and platform 500 in accordance with one or more embodiments of the present disclosure. However, not all of these components may be required to practice one or more embodiments, and variations in the arrangement and type of the components may be made without departing from the spirit or scope of various embodiments of the present disclosure.

In some embodiments, the client device 502a, client device 502b through client device 502n shown each at least includes a computer-readable medium, such as a random-access memory (RAM) 508 coupled to a processor 510 or FLASH memory. In some embodiments, the processor 510 may execute computer-executable program instructions stored in memory 508. In some embodiments, the processor 510 may include a microprocessor, an ASIC, and/or a state machine. In some embodiments, the processor 510 may include, or may be in communication with, media, for example computer-readable media, which stores instructions that, when executed by the processor 510, may cause the processor 510 to perform one or more steps described herein.

In some embodiments, examples of computer-readable media may include, but are not limited to, an electronic, optical, magnetic, or other storage or transmission device capable of providing a processor, such as the processor 510 of client device 502a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, client devices 502a through 502n may also comprise a number of external or internal devices such as a mouse, a CD-ROM, DVD, a physical or virtual keyboard, a display, or other input or output devices. In some embodiments, examples of client devices 502a through 502n (e.g., clients) may be any type of processor-based platforms that are connected to a network 506 such as, without limitation, personal computers, digital assistants, personal digital assistants, smart phones, pagers, digital tablets, laptop computers, Internet appliances, and other processor-based devices. In some embodiments, client devices 502a through 502n may be specifically programmed with one or more application programs in accordance with one or more principles/methodologies detailed herein. In some embodiments, client devices 502a through 502n may operate on any operating system capable of supporting a browser or browser-enabled application, such as Microsoft™, Windows™, and/or Linux. In some embodiments, client devices 502a through 502n shown may include, for example, personal computers executing a browser application program such as Microsoft Corporation's Internet Explorer™, Apple Computer, Inc.'s Safari™, Mozilla Firefox, and/or Opera. In some embodiments, through the client devices 502a through 502n, user 512a, user 512b through user 512n, may communicate over the network 506 with each other and/or with other systems and/or devices coupled to the network 506. As shown in FIG. 5, server devices 504 and 513 may include processor 505 and processor 514, respectively, as well as memory 517 and memory 516, respectively. In some embodiments, the server devices 504 and 513 may be also coupled to the network 506. In some embodiments, one or more client devices 502a through 502n may be mobile clients.

In some embodiments, at least one database of databases 507 and 515 may be any type of database, including a database managed by a database management system (DBMS). In some embodiments, an DBMS-managed database may be specifically programmed as an engine that controls organization, storage, management, and/or retrieval of data in the respective database. In some embodiments, the DBMS-managed database may be specifically programmed to provide the ability to query, backup and replicate, enforce rules, provide security, compute, perform change and access logging, and/or automate optimization. In some embodiments, the DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the DBMS-managed database may be specifically programmed to define each respective schema of each database in the DBMS, according to a particular database model of the present disclosure which may include a hierarchical model, network model, relational model, object model, or some other suitable organization that may result in one or more applicable data structures that may include fields, records, files, and/or objects. In some embodiments, the DBMS-managed database may be specifically programmed to include metadata about the data that is stored.

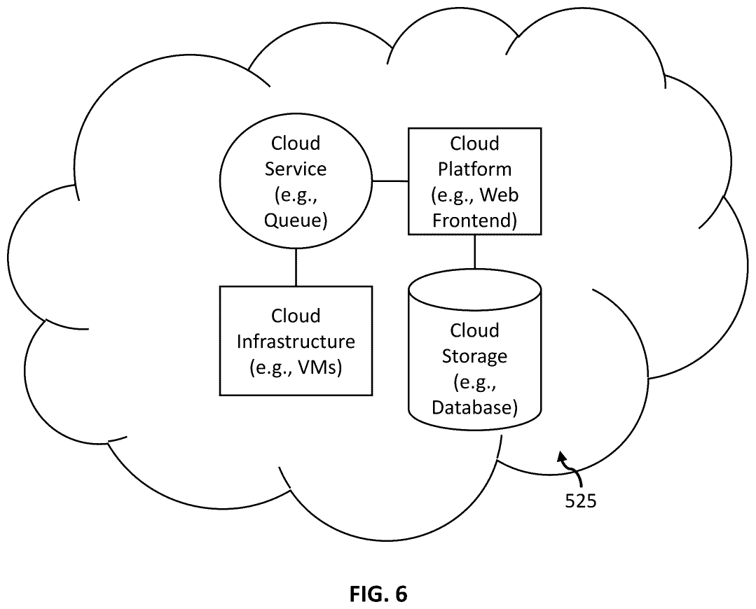

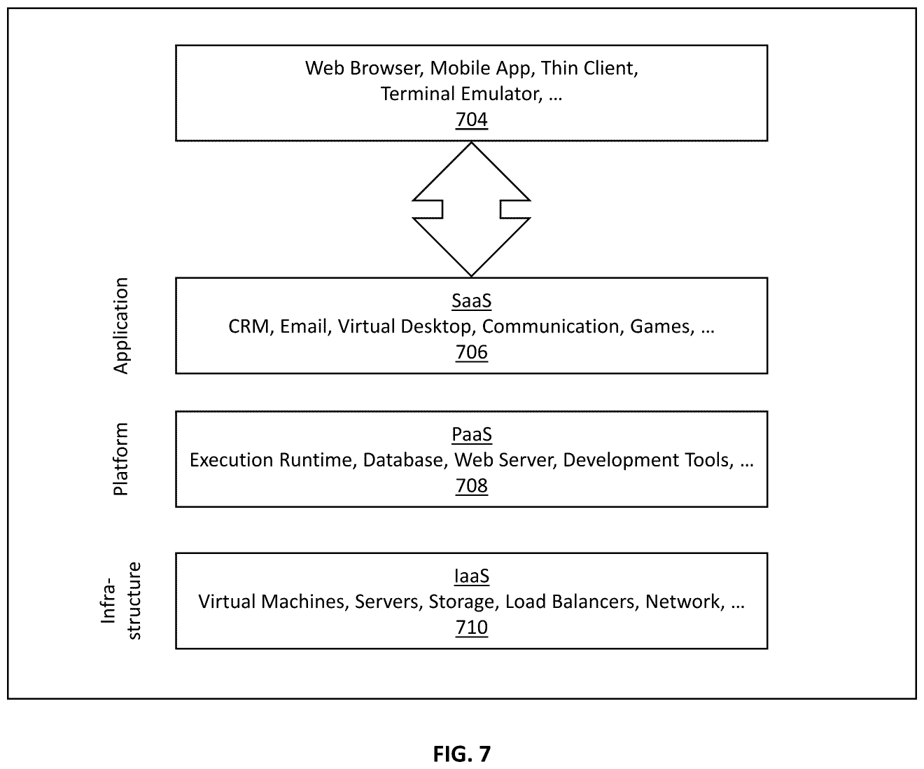

In some embodiments, the inventive computer-based systems/platforms, the inventive computer-based devices, and/or the inventive computer-based components of the present disclosure may be specifically configured to operate in a cloud computing/architecture 525 such as, but not limiting to: infrastructure a service (IaaS) 710, platform as a service (PaaS) 708, and/or software as a service (Saas) 706 using a web browser, mobile app, thin client, terminal emulator or other endpoint 704. FIGS. 6 and 7 illustrate schematics of implementations of the cloud computing/architecture(s) in which the inventive computer-based systems/platforms, the inventive computer-based devices, and/or the inventive computer-based components of the present disclosure may be specifically configured to operate.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

In some embodiments, inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

In some embodiments, the NFC can represent a short-range wireless communications technology in which NFC-enabled devices are “swiped,” “bumped,” “tap” or otherwise moved in close proximity to communicate. In some embodiments, the NFC could include a set of short-range wireless technologies, typically requiring a distance of 10 cm or less. In some embodiments, the NFC may operate at 13.56 MHz on ISO/IEC 18000-3 air interface and at rates ranging from 106 kbit/s to 424 kbit/s. In some embodiments, the NFC can involve an initiator and a target; the initiator actively generates an RF field that can power a passive target. In some embodiment, this can enable NFC targets to take very simple form factors such as tags, stickers, key fobs, or cards that do not require batteries. In some embodiments, the NFC's peer-to-peer communication can be conducted when a plurality of NFC-enable devices (e.g., smartphones) within close proximity of each other.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various known or to be known computer platforms such as, but not limited to: (1) FreeBSD, NetBSD, OpenBSD; (2) Linux; (3) Microsoft Windows™; (4) OpenVMS™; (5) OS X (MacOS™); (6) UNIX™; (7) Android; (8) iOS™; (9) Embedded Linux; (10) Tizen™; (11) WebOS™; (12) Adobe AIR™; (13) Binary Runtime Environment for Wireless (BREW™); (14) Cocoa™ (API); (15) Cocoa™ Touch; (16) Java™ Platforms; (17) JavaFX™; (18) QNX™; (19) Mono; (20) Google Blink; (21) Apple WebKit; (22) Mozilla Gecko™; (23) Mozilla XUL; (24).NET Framework; (25) Silverlight™; (26) Open Web Platform; (27) Oracle Database; (28) Qt™; (29) SAP Net Weaver™; (30) Smartface™; (31) Vexi™; (32) Kubernetes™ and (33) Windows Runtime (WinRT™) or other suitable computer platforms or any combination thereof.

In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, software specifically programmed in accordance with one or more principles of the present disclosure may be downloadable from a network, for example, a website, as a stand-alone product or as an add-in package for installation in an existing software application. For example, software specifically programmed in accordance with one or more principles of the present disclosure may also be available as a client-server software application, or as a web-enabled software application. For example, software specifically programmed in accordance with one or more principles of the present disclosure may also be embodied as a software package installed on a hardware device.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

As used herein, terms “proximity detection,” “locating,” “location data,” “location information,” and “location tracking” refer to any form of location tracking technology or locating method that can be used to provide a location of, for example, a particular computing device, system or platform of the present disclosure and any associated computing devices, based at least in part on one or more of the following techniques and devices, without limitation: accelerometer(s), gyroscope(s), Global Positioning Systems (GPS); GPS accessed using Bluetooth™; GPS accessed using any reasonable form of wireless and non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For case, at times the above variations are not listed or are only partially listed; this is in no way meant to be a limitation.

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTR0, SHA-1, SHA-2, Tiger (TTH), WHIRLPOOL, RNGs).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

The aforementioned examples are, of course, illustrative and not restrictive.

At least some aspects of the present disclosure will now be described with reference to the following numbered clauses.
1. A method, comprising:

### [GT to Complete Upon Finalization of Claims]

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

What is claimed is:

1. A method comprising:
receiving, by at least one processor associated with a wireless communication network, a solicited wireless communication from an electronic device in response to a request, the solicited wireless communication being transmitted by the electronic device over a channel of the wireless communication network to an access point;
extracting, by the at least one processor, channel characteristics from the solicited wireless communication, the channel characteristics being timing-dependent effects on the channel associated with the solicited wireless communication;
generating, by the at least one processor, a device fingerprint based at least in part on the channel characteristics, the device fingerprint being specific to hardware of the electronic device; and
determining, by the at least one processor, an identification associated with the electronic device based at least in part on the device fingerprint matching a stored device profile representative of at least one pre-stored electronic device.

2. The method of claim 1, wherein the at least one pre-stored electronic device comprises a particular fingerprint of at least one previous electronic device that has been previously fingerprinted.

3. The method of claim 1, wherein the identification is indicative of a particular device.

4. The method of claim 1, wherein the identification is indicative of a particular type of device.

5. The method of claim 4, wherein the particular type of device comprises a particular device model.

6. The method of claim 1, further comprising:
communicating, by the at least one processor, the device fingerprint to a remote server, the remote server being configured to analyze the device fingerprint relative to the stored device profile; and
receiving, by the at least one processor, an indication of the identification from the remote server in response to the device fingerprint.

7. The method of claim 1, wherein the request comprises an authentication challenge, and the response is derived from at least one pre-shared cryptographic secret.

8. The method of claim 1, wherein the channel characteristics comprise at least one of:
channel frequency response, or
channel state information.

9. The method of claim 1, wherein the access point comprises a Wi-Fi access point.

10. A system comprising:
at least one processor of a wireless communication network, wherein the at least one processor is configured to:
receive a solicited wireless communication from an electronic device in response to a request, the solicited wireless communication being transmitted by the electronic device over a channel of the wireless communication network to an access point;
extract channel characteristics from the solicited wireless communication, the channel characteristics being timing-dependent effects on the channel associated with the solicited wireless communication;
generate a device fingerprint based at least in part on the channel characteristics, the device fingerprint being specific to hardware of the electronic device; and
determine an identification associated with the electronic device based at least in part on the device fingerprint matching a stored device profile representative of at least one pre-stored electronic device.

11. The system of claim 10, wherein the at least one pre-stored electronic device comprises a particular fingerprint of at least one previous electronic device that has been previously fingerprinted.

12. The system of claim 10, wherein the identification is indicative of a particular device.

13. The system of claim 10, wherein the identification is indicative of a particular type of device.

14. The system of claim 13, wherein the particular type of device comprises a particular device model.

15. The system of claim 10, further comprising:
communicate the device fingerprint to a remote server, the remote server being configured to analyze the device fingerprint relative to the stored device profile; and
receive an indication of the identification from the remote server in response to the device fingerprint.

16. The system of claim 10, wherein the request comprises an authentication challenge, and the response is derived from at least one pre-shared cryptographic secret.

17. The system of claim 10, wherein the channel characteristics comprise at least one of:
channel frequency response, or
channel state information.

18. The system of claim 10, wherein the access point comprises a Wi-Fi access point.

19. A method comprising:
receiving, by a Wi-Fi access point of a Wi-Fi network, a solicited wireless communication from an electronic device in response to a request, the solicited wireless communication being transmitted by the electronic device over a channel of the Wi-Fi network;
extracting, by the Wi-Fi access point, channel characteristics from the solicited wireless communication, the channel characteristics being timing-dependent effects on the channel associated with the solicited wireless communication;
generating, by the Wi-Fi access point, a device fingerprint based at least in part on the channel characteristics, the device fingerprint being specific to hardware of the electronic device;
communicating, by the Wi-Fi access point, the device fingerprint to a remote server, the remote server being configured to analyze the device fingerprint relative to a stored device profile;
receiving, by the Wi-Fi access point, an indication of identification from the remote server in response to the device fingerprint, the identification being indicative of at least one of a device identity or a device type; and
determining, by the Wi-Fi access point, an authentication associated with the electronic device based at least in part on the indication of identification.

20. The method of claim 19, wherein the channel characteristics comprise at least one of:
channel frequency response, or
channel state information.
